(19) United States
(12) Patent Application Publication
(10) Pub. No.: US 2013/0193068 A1
(43) Pub. Date: Aug. 1, 2013

(54) MODIFICATION OF EXISTING WASTEWATER SYSTEMS WITH SUBSTRATE SUPPORTED BIOFILMS

(71) Applicants: R. Gavin Jones, Huntsville, TX (US); Phillip Grisham, Bullard, TX (US); Kenneth Wilson, Tyler, TX (US); Sabin Holland, The Woodlands, TX (US); Michael D. Rainone, Palestine, TX (US)

(72) Inventors: R. Gavin Jones, Huntsville, TX (US); Phillip Grisham, Bullard, TX (US); Kenneth Wilson, Tyler, TX (US); Sabin Holland, The Woodlands, TX (US); Michael D. Rainone, Palestine, TX (US)

(21) Appl. No.: 13/671,894

(22) Filed: Nov. 8, 2012

Related U.S. Application Data
(63) Continuation of application No. 13/480,010, filed on May 24, 2012, now abandoned.
(60) Provisional application No. 61/489,935, filed on May 25, 2011.

(51) Int. Cl. C02F 3/02

(52) U.S. Cl. CPC C02F 3/02
USPC 210/615; 210/150

(57) ABSTRACT

In some embodiments, a wastewater treatment system may reduce contaminants in water. A system may include one or more basins which include a substrate that supports a biofilm. The bacteria used to form the biofilm may be selected to maximize the reduction of contaminants in water. Various components of the wastewater treatment system may be optimized to improve the efficiency and energy consumption of the wastewater system.

### PRIORITY CLAIM

This application is a continuation of U.S. patent application Ser. No. 13/480,010 filed May 24, 2012 which claims priority to U.S. Provisional Application No. 61/489,935 filed on May 25, 2011.

### BACKGROUND OF THE INVENTION

1. Field of the Invention

The present invention generally relates to systems and methods for treating water. More particularly, the invention relates to the reduction of contaminants from wastewater using bacteria.

2. Description of the Relevant Art

Wastewater treatment facilities are well known in the art. The basic function of a wastewater treatment facility is to treat contaminated water (e.g., raw wastewater) to produce water that may be potable and/or discharged to lakes, rivers and streams. Challenges for wastewater treatment facilities include disposal of solids (e.g., sludge and/or biosolids) and/or removal of contaminants from the wastewater. Increased production of sewage, environmental impacts, and regulations regarding disposal of the sewage have made the disposal of solids and/or removal of contaminants from the wastewater more challenging.

Primary objectives in the wastewater treatment industry include improving the influent quality, improving the treated effluent quality, complying with effluent limitations, and seeking more effective and efficient treatment, notably in the removal of inorganic constituents. The majority of these objectives are being met; however, a byproduct of these efforts has been the increased generation of solids and biological contaminants. In many cases, the increase in solids production has severely challenged existing solids processing and disposal methods.

The current infrastructure for the United States and other industrialized nations is quickly becoming antiquated. Within the United States, many municipalities are exceeding their designed capacity and are incapable of maintaining effluent requirements. Many of the municipal wastewater treatment plants no longer have the resources, financial or land, to increase their capacity and as a result will be incapable of meeting their obligations and thus be fined by the various regulatory entities.

The most cost-efficient method would be to integrate new technologies into current infrastructure that will allow for wastewater treatment plants to increase throughput while minimizing major capital expenditures.

### SUMMARY OF THE INVENTION

In one embodiment, a wastewater treatment system includes a primary treatment system, wherein the primary treatment system is configured to remove at least a portion of solid material from a wastewater stream; and a secondary treatment system coupled to the primary treatment system, the secondary treatment system comprising a basin and one or more substrates positioned in fixed locations within the basin. One or more bacteria capable of reducing the contaminants in the wastewater stream are disposed in the basin, wherein one or more of the bacteria couple to one or more of the substrates to form a biofilm.

In some embodiments, one or more compartments are defined within the basin, the one or more compartments include one or more of the substrates and one or more oxygen containing gas inlets. In some embodiments, a plurality of compartments divide the basin into a plurality of substantially equal parts. The compartments, in some embodiments, may be defined by one or more concrete walls positioned in the basin.

In some embodiments, the basin is an aeration basin that has been modified to include the one or more substrates. The basin may include one or more air diffusers positioned such that air passes from the air diffusers toward one or more of the substrates.

In some embodiments, the substrate is a polymer substrate. In one embodiment, one or more of the bacteria include primary adherer bacteria that couple to the substrate and wherein one or more bacteria include secondary bacteria which couple to the primary adherer bacteria to form a biofilm. In some embodiments, the secondary bacteria are substantially unable to couple to the substrate. Examples of bacteria that may be present in a bioreactor include one or more of the following: bacteria of the genus Caulobacter; bacteria of the genus Enterobacter; bacteria of the genus Pseudomonas; bacteria of the genus Gordonia; bacteria of the genus Bacillus; bacteria of the genus Agrobacterium; and bacteria of the genus Zoogloea.

One or more bacteria generators may be coupled to the basin, wherein one or more of the bacteria capable of reducing the concentration of contaminants in the wastewater stream are introduced into the basin from one or more of the bacteria generators. In some embodiments, a plurality of bacteria generators configured to supply bacteria to one or more of the bioreactors, wherein each of the bacteria generators is independently operable.

In some embodiments, a tertiary treatment system is coupled to the secondary treatment system, wherein the tertiary treatment system receives an effluent stream from second treatment system and produces a further purified water stream from the effluent stream.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a schematic diagram of a wastewater treatment system;

FIG. 2 depicts a projection view of a buffer system of a wastewater treatment system;

FIG. 3 depicts a partially open projection view of a sedimentation system of a wastewater treatment system;

FIG. 4 depicts a partially open projection view of an embodiment of a bioreactor of a wastewater treatment system;

FIG. 5 depicts a projection view of an embodiment of a substrate that includes a plurality of corrugated sheets;

FIG. 6 depicts a partially open projection view of a portable structure that includes a pair of bioreactors and a sedimentation system;

FIG. 7 depicts a projection view of a control compartment;

FIG. 8 depicts a schematic diagram of a bacteria generation system;

FIG. 9 depicts a cross-sectional view of a control unit;

FIG. 10 depicts a schematic diagram of a non-buffered wastewater treatment system;

FIG. 11 depicts a schematic diagram of a buffered wastewater treatment system;

FIG. 12 depicts a cross-section view on an aeration basin that includes one or more substrates placed in fixed positions within the aeration basin; and

FIG. 13 depicts a cross-section view on an alternate embodiment of an aeration basin that includes one or more substrates placed in fixed positions within the aeration basin.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

An “air source” refers to a device capable of providing air or other gasses to a liquid.

“Bacteria” refers to any member of the Bacteria Domain.

A “bacteria generator” refers to a device capable of allowing one or more bacteria to grow and/or reproduce.

A “biofilm” refers to a collection of more than one bacteria coupled together.

A “contaminant” refers to any unwanted substance or compound.

“Coupling” refers to attaching, bonding, adhering, welding, or a direct connection of two or more objects.

“Enteric bacteria” refers to bacteria that are found in the digestive tract of animals.

A “filament” refers to a portion of a bacterium that extends from the body of the bacterium.

“Foam” refers to an aggregate of gas bubbles formed in a liquid or solid. Foam in a liquid may suspend solid particles and inhibit settling of the solid particles to a bottom of a container.

A “footprint” refers to an area on a surface an object occupies.

“Gene-up regulation” refers to activation of a property of a bacterium after the bacterium couples to a substrate. For example, a gene may be activated, protein synthesis may occur, and/or metabolic activity may be increased or decreased during gene-up regulation of a bacterium.

A “heterotroph” is an organism that requires organic compounds as a carbon source for growth and development. A heterotroph is not able to use carbon dioxide as its sole carbon source.

A “hydrophobic substrate” refers to a substrate that does not form hydrogen bonds with itself, which causes it to at least partially repel water.

An “oligotroph” refers to an organism that can live in environments with a carbon concentration of less than 1 ppm.

An “organic compound” refers to a compound that includes carbon. An organic compound may include elements other than carbon, such as oxygen, nitrogen, sulfur, and/or metals.

“Primary adherer bacteria” refers to any member of the Bacteria Domain capable of coupling to a substrate and/or other bacteria.

“Stagnant regions” refers to areas that are not substantially flowing.

“Secondary adherer bacteria” refers to any member of the Bacteria Domain capable of coupling to other bacteria with a greater binding affinity than the binding affinity of the bacteria for a substrate.

“Reducing contaminants in water” refers to reducing an amount of contaminant in water, degrading contaminants, altering contaminants (e.g., altering a metal contaminant such that it precipitates), absorbing contaminants, immobilizing contaminants, and/or removing one or more contaminants from water.

“Wastewater” refers to a fluid comprising one or more contaminants. Contaminants include organic compounds, bacteria, and metal ions. Wastewater may also include solid inert materials such as undissolved polymeric materials, dirt, and sand.

A wastewater treatment facility treats wastewater to produce potable water, effluent, and biosolids. The treatment process typically includes a) removal of solids; b) transformation (e.g., oxidization) of dissolved and particulate biodegradable constituents into acceptable end products; c) capture and incorporation of suspended and nonsettleable colloidal solids into a biological floc or biofilm; d) transform or remove nutrients, such as nitrogen and phosphorus; and e) in some cases, the removal of specific trace organic constituents and compounds. By means of biological processes (e.g., biological respiration and synthesis) occurring in wastewater treatment facilities, most of the organic material received is converted to carbon dioxide, water and biosolids.

Treatment of raw wastewater may include passing the raw wastewater through a primary treatment system, a secondary treatment system, and a disinfection system to produce potable water and clean effluent. The clean effluent may be discharged into one or more receiving water bodies. In the primary treatment system, the wastewater passes through a settling tank. In the settling tank, floating material and/or material that has settled out from the wastewater is separated from the wastewater.

During the secondary treatment process, the wastewater is subjected to biological processes to produce water, carbon dioxide and sludge. These processes include, but are not limited to, waste activated sludge process, sequence batch reactors (SBRs), microbiological reactors (MBRs), and oxidization ditches. All of these processes produce sludge that may be further processed to biosolids.

The sludge may be transported to a solids treatment system to be reduced to biosolids. A water content of the sludge may be reduced so that the biosolids can be converted into recoverable energy (e.g., burned) and/or recycled (e.g., biosolids may be recycled into landscaping, gardening, soil improvement, land reclamation, forestry and/or agriculture processes). Processing of the sludge to biosolids may account for about 40% to 60% of the total operating costs of the wastewater treatment facility, thus a need for cost effective technology that reduces the mass and volume of biosolids is needed. Incorporating one or more biological wastewater treatment systems in wastewater facilities may efficiently reduce the mass and volume of biosolids, thus lowering the overall operation costs for the wastewater treatment facilities.

In one embodiment, a biological wastewater treatment system includes one or more bioreactors. The wastewater treatment system further includes additional components that may assist in the transport of wastewater to the bioreactors. For example, a biological wastewater treatment system may include a generator, a filtration system, a control system, a power distribution system, a bacteria on-site fermenter, a primary settling tank, pumps, blower(s), air diffusers, one or more biofilm substrates, and sensors.

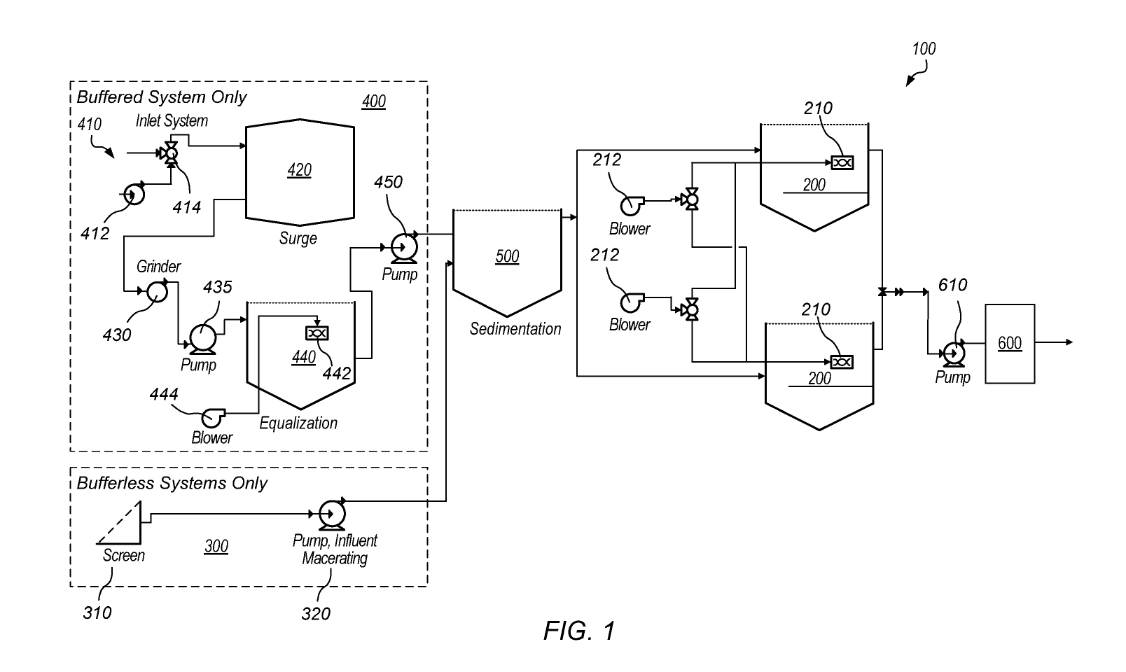

FIG. 1 depicts a schematic diagram of a biological wastewater treatment system 100. Biological wastewater treatment system 100 includes one or more bioreactors 200. One or more of bioreactors 200 include one or more substrates. In an embodiment, one or more bacteria disposed in bioreactor 200 at least partially adhere to one or more of substrates. During treatment of a wastewater stream, wastewater is introduced into one or more of bioreactors 200 and contacted with a biofilm formed on one or more substrates disposed within bioreactors 200. Interaction of the wastewater stream with bacteria present in bioreactor (e.g., bacteria coupled to a substrate) allows the bacteria to reduce contaminants in the wastewater stream.

Biological wastewater system 100 may be configured in different wastewater input configurations. For example, wastewater system may be configured for buffered or non-buffered wastewater input streams. For installations that include a customer supplied wastewater reservoir, a non-buffered input configuration may be used. In a non-buffered transfer system 300, wastewater stream is conducted to an influent filter 310. Influent filter 310 may be an influent screen which separates some of the solid matter from the wastewater stream. After passing through influent filter 310 the wastewater stream may be conducted to a grinding system 320. Grinding system 320 receives a wastewater stream that includes solid matter and reduces the size of the solid matter in the wastewater stream. Examples of a grinding system include, but are not limited to, grinders and macerating pumps. The resulting pretreated wastewater stream is passed, in some embodiments, to a sedimentation system 500, using a pump. In some embodiments, grinding system 320 includes a pump for transferring the wastewater through the grinding system and to sedimentation system 500 (e.g., using a macerating pump).

For those installations that lack sufficient infrastructure to provide a constant supply of wastewater for processing, a wastewater treatment system may include a buffer unit 400 that accepts wastewater from a number of sources with varying flow rates. In an embodiment, a buffer unit 400 includes an inlet system 410 that includes an influent pump 412 and an inlet bypass valve 414. Influent pump 412 may be used to pump an influent wastewater stream into a surge tank 420. For example, wastewater may be pumped into surge tank 420 from a holding basin/lift station. In some embodiments, an influent pump may not be required. In such embodiments, an influent bypass valve 414 may allow a wastewater stream to bypass influent pump 412. Bypass valve may be an electrically actuated valve. An influent pump may not be necessary if the wastewater stream is pressurized when it is conducted to the wastewater treatment system. For example, a holding tank (e.g., of a truck) may include a pump for sending wastewater out of the holding tank. Surge tank 420 collects wastewater and has a sufficient capacity to be able to provide a substantially constant supply of wastewater into the wastewater treatment system based on the frequency of wastewater delivery to the system.

Wastewater stored in surge tank 420 may be conducted to a grinding system 430. In some embodiments a buffer pump 435 may be coupled to grinding system to conduct the wastewater stream into an equalization tank 440. Equalization tank 440 may include one or more gas diffusers 442 coupled to blower 444. In some embodiments, oxygen may be added to wastewater held in equalization tank by sending air (e.g., using blowers 444) or oxygen (e.g., from a compressed oxygen source) into the equalization tank. Gas diffusers 442 may be coupled to the incoming oxygen source to disperse the incoming oxygen throughout the wastewater in equalization tank 440. Water may be transferred from equalization tank 440 to a sedimentation system 500, using transfer pump 450. Transfer pump 450 moves wastewater from equalization tank 440 to sedimentation system 500 at a controlled rate.

Sedimentation system 500 receives a waste stream from a buffer system 400 or from a non-buffered transfer system 300. Sedimentation system 500 removes at least a portion of solid material in the wastewater conducted to the sedimentation system to provide an at least partially clarified wastewater stream to the one or more bioreactors 200. The flow of wastewater through sedimentation system 500 is controlled, in part by either a pump in grinding system 300 (for non-buffered systems) or by transfer pump 450 (in buffered systems).

Bioreactors 200 may receive an at least partially clarified wastewater stream from sedimentation system 500. Bioreactors 200 include one or more substrates and one or more bacteria that at least partially adhere to the substrate. In some embodiments, oxygen may be added to the bioreactors by sending air (e.g., using blowers 212) or oxygen (e.g., from a compressed oxygen source) into the bioreactors. Gas diffusers 210 may be coupled to the incoming oxygen source to disperse the incoming oxygen throughout the wastewater in bioreactors 200.

Water may be transferred from bioreactors 200 to a purification system 600, using effluent transfer pump 610. Transfer pump 610 moves wastewater from bioreactors 200 to purification system 600 at a controlled rate. In one embodiment, purification system 600 may include a filtration system that receives an effluent stream from one or more of the bioreactors and produces a filtered water stream. In an embodiment, purification system 600 includes a metal removing system (e.g., an electrocoagulation system) that receives an effluent stream from one or more bioreactors and reduces the concentration of metal ions in the effluent stream. In some embodiments, refining system may include a filtration system and a metal removing system.

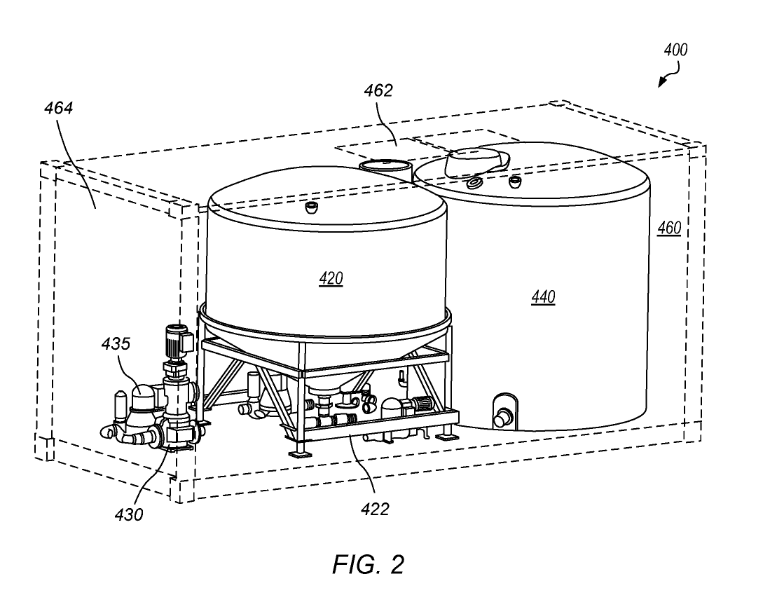

FIG. 2 depicts an embodiment of a buffer system 400. Buffer system 400 includes a surge tank 420 and an equalization tank 440. In some embodiments, buffer system 400 may be stored in a portable structure 460. For example, buffer system 400 may be stored in a high cube, 20′ ISO container. As shown in FIG. 2, the components of buffer system 400 may be stored in a single portable structure. In some embodiments, portable structure 460 includes integral roof ports 462 and a side door 464 that allow for accessibility to the tanks and equipment within the structure.

Surge tank 420 may, in some embodiments, be a cone-bottom tank. Surge tank 420 is supported by a complementary frame 422 which allows access to the bottom. Use of a cone bottom tank will allow a preliminary separation of solids from the waste water stream. As wastewater enters surge tank 420, solids will collect in the bottom of the tank. Bottom access of surge tank 420 provides an access point for the removal of solid materials that collect on the bottom of the tank. Surge tank 420 is coupled to a wastewater inlet system 410 (depicted schematically in FIG. 1).

Buffer system 400 also includes an equalization tank 440. Equalization tank 440 may include an oxygen containing gas inlet. In some embodiments, oxygen may be added to wastewater held in equalization tank by sending air (e.g., using blowers 444) or oxygen (e.g., from a compressed oxygen source) into equalization tank 440 through oxygen containing gas inlet. Gas diffusers 442 may be coupled to the incoming oxygen containing gas inlet to disperse the incoming oxygen containing gas throughout the wastewater in equalization tank 440.

Together surge tank 420 and equalization tank 440 may provide storage of a sufficient amount of wastewater to allow substantially continuous operation of the wastewater treatment system. In some embodiments, buffer system 400 has a capacity of between about 3000 gallons to about 6000 gallons; or between about 3500 gallons to about 5000 gallon. In some embodiments, surge tank 420 has a lower capacity than equalization tank 440. In some embodiments, surge tank 420 has a capacity of between about 1000 gallons to about 2500 gallons, while equalization tank 440 has a capacity of between about 2000 gallons and about 3500 gallons.

Surge tank 420 may be coupled to equalization tank 440 through a grinding system 430 and an buffer pump 435. During use wastewater, collected in surge tank 420, may be passed into grinding system 430. Grinding system 430 receives a wastewater stream that includes solid matter and reduces the size of the solid matter in the wastewater stream. In an embodiment, grinding system 430 includes an in-line grinder. Buffer pump 435 is coupled to grinding system 430 to conduct wastewater from surge tank 440 through the grinding system to equalization tank.

Integral sensors for flow control and biological condition feedback may be mounted to surge tank 420 and/or equalization tank 440. Specifically, the tanks may incorporate one or more sensors, including, but not limited to fluid level sensors, dissolved oxygen sensors, and PH/oxidation reduction potential sensors, as depicted in FIG. 1. Electrical power and signal wires are distributed in the buffer unit container coupling the included sensors to a controller.

Buffer system 400 offers advantages over non-buffered wastewater delivery, even when a constant supply of wastewater is available. When non-buffered wastewater is delivered, the wastewater typically will have a higher solid level and a lower intrinsic oxygen level than wastewater delivered from a buffer system. The pretreated wastewater, obtained from a buffer system, will allow the bioreactors to operate more efficiently and for longer periods of time, due to the reduced amount of solids and the increased oxygen content.

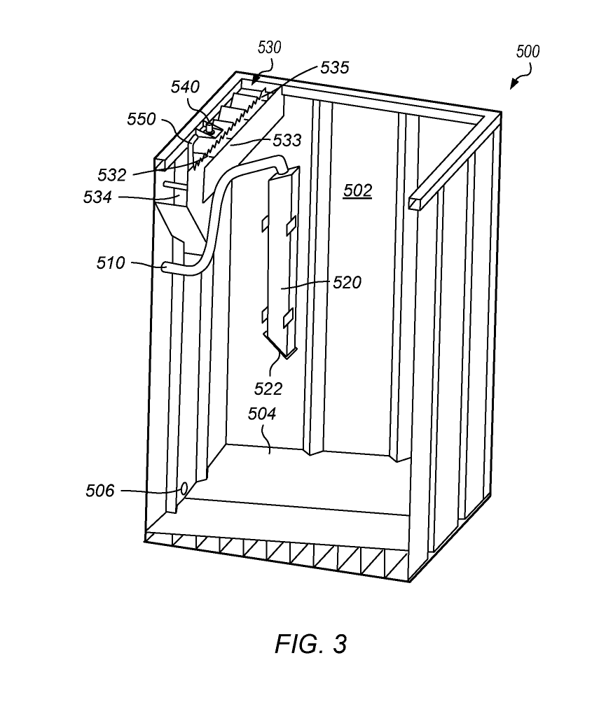

A wastewater stream from a non-buffered source, or a pretreated wastewater stream from a buffer system, may be conducted into a sedimentation system 500. FIG. 3 depicts a partially open projection view of a sedimentation system 500. Sedimentation system 500 includes an inlet hose 510 coupled to an inlet conduit 520. Wastewater is introduced into sedimentation system through inlet hose 510 and into inlet conduit 520. Inlet conduit 520 includes an opening 522 through which the wastewater enters the sedimentation system body 502. Opening 522 is preferably positioned proximate to the lower half of the sedimentation system to ensure that the incoming wastewater is directed toward the bottom of body 502. The bottom of sedimentation system 500 includes a sloped floor 504. During use, solid material, that is carried into sedimentation system 500 in the wastewater, settles on sloped floor 504, which directs the solid material toward solids outlet 506. Sloped floor 504 helps to ensure that any solid material that settles out of the wastewater is directed toward the solids outlet 506. Sloped floor may have an approximately 10% to approximately 35% grade from horizontal. In an embodiment, sloped floor may have approximately 23% to approximately 27% grade from horizontal. Sedimentation system 200, in some embodiments, has a fluid capacity of between about 1000 gallons to about 2500 gallons.

Sedimentation system body includes an outlet system 530. Outlet system 530 includes a weir system 532 and an outlet conduit 534. Weir system 532 is configured to inhibit the passage of at least a portion of the solid matter in the wastewater from passing into the outlet conduit 534. Weir system 532 includes a first wall 533 and an opposing second wall 535. Together first wall 533 and second wall 535 define a conduit through which the wastewater introduced into body 502 passes. As shown in FIG. 3, first wall 533 and second wall 535 may extend only part way down the length of the body. This ensures that only wastewater that is near the top of body 502 enters the weir system. Thus, incoming wastewater is directed toward the bottom of body 502, forcing wastewater that has already been introduced to move toward the top of body 502 and weir system 532. The relatively narrow opening formed between first wall 533 and the second wall 535 ensures that a limited amount of wastewater enters weir system 532 during use. Wastewater entering weir system 532, passes through the conduit defined by first wall 533 and second wall 535 and over the second wall into outlet conduit 534. In some embodiments, first wall 533 extends to the roof of the body so that wastewater entering weir system 532 is inhibited from leaving the weir system. In one embodiment, second wall 535 includes a saw tooth upper surface, as depicted in FIG. 3. During use, wastewater passes through the conduit defined by first wall 533 and second wall 535 and over the saw tooth upper surface of the second wall into outlet conduit 534. A saw tooth upper surface on second wall 535 helps to improve sediment removal from the wastewater.

Sedimentation system also includes a fluid level sensor 540 to monitor the level of wastewater in the sedimentation system. Fluid level sensor 540 is coupled to a controller which is coupled to the transfer pump 450. Controller, in some embodiments, will control the flow rate of transfer pump 450, at least in part based on the fluid level in sedimentation system 500.

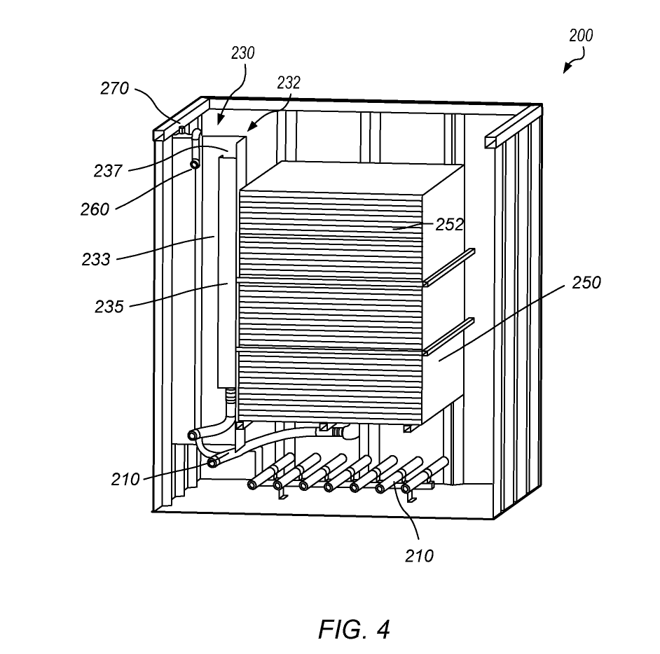

The at least partially clarified waster from produced from the sedimentation system is transferred to one or more bioreactors 200. FIG. 4 depicts a partially open projection view of an embodiment of a bioreactor 200. Bioreactor 200 includes one or more substrates 250 disposed in bioreactor 200. In an embodiment, one or more bacteria disposed in bioreactor 200 at least partially adhere to one or more of substrates. During treatment of a wastewater stream, wastewater is introduced into one or more of bioreactors 200 from sedimentation system 500 and contacted with a biofilm formed on one or more substrates 250 disposed within bioreactors 200. Interaction of the wastewater stream with bacteria present in bioreactor 200 (e.g., bacteria coupled to a substrate) allows the bacteria to reduce contaminants in the wastewater stream. Wastewater enters bioreactor 200 through an inlet hose 210 having an outlet positioned proximate to the bottom of the bioreactor body 202. In some embodiments, the outlet of inlet hose 210 is positioned below one or more substrates 250 to ensure that the incoming wastewater contacts one or more substrates. In some embodiments, bioreactor 200 has a fluid capacity of about 1500 gallons to about 5000 gallons.

Bioreactor 200 includes an outlet system 230. Outlet system 230 includes a weir system 232 and an outlet conduit 234. Weir system 232 is configured to inhibit the passage of at least a portion of the solid matter in the bioreactor from passing into the outlet conduit 234. Weir system 232 includes a first wall 233 and an opposing second wall 235. Together first wall 233 and second wall 235 define a weir conduit 237 through which the wastewater introduced into bioreactor 200 passes. The relatively narrow area defined by first wall 233 ensures that a limited amount of wastewater enters weir system 232 during use. A portion of the wastewater entering weir system 232, passes over first wall 233 and through the weir conduit 237 into outlet conduit 234. Only a portion of the wastewater that passes over the first wall enters weir conduit 237, the remainder of the wastewater passes through the weir system back into the reactor. In this manner, the reduction of contaminants in a wastewater stream can be maximized while maintaining a continuous flow.

In an embodiment, bioreactor 200 includes an oxygen containing gas inlet 260 which receives an oxygen containing gas. An oxygen containing gas may be air or oxygen obtained from a compressed gas source. An oxygen containing gas enters bioreactor 200 through oxygen containing gas inlet 260 and is conducted to one or more diffusers 210. The diffusers disperse the incoming oxygen containing gas throughout the bioreactor. In some embodiments, diffusers create bubbles of oxygen containing gas which are dispersed within bioreactor 200.

Bioreactor 200 includes one or more substrates. A substrate may be a structure on which a biofilm grows in a container. One or more substrates are fixed within a bioreactor 200. In some instances, one or more substrates are removably coupled to the bioreactor body to allow easy removal for cleaning or replacement of the substrate. A substrate may be formed of polymeric material, including, but not limited to, polyvinyl chloride (PVC), polyethylene, and polypropylene. Other materials such as metals and natural materials (e.g., cotton) may be used to form one or more of the substrates. In certain embodiments, the material selected to form the substrate may not substantially degrade in the presence of the wastewater to be treated. In some embodiments, the substrate is a ceramic substrate. For example, a substrate may include a plurality of porous ceramic rocks. The rocks may be constrained to a mechanism to build a colony, with respect to each other, such that a plurality of passages are defined by the rocks.

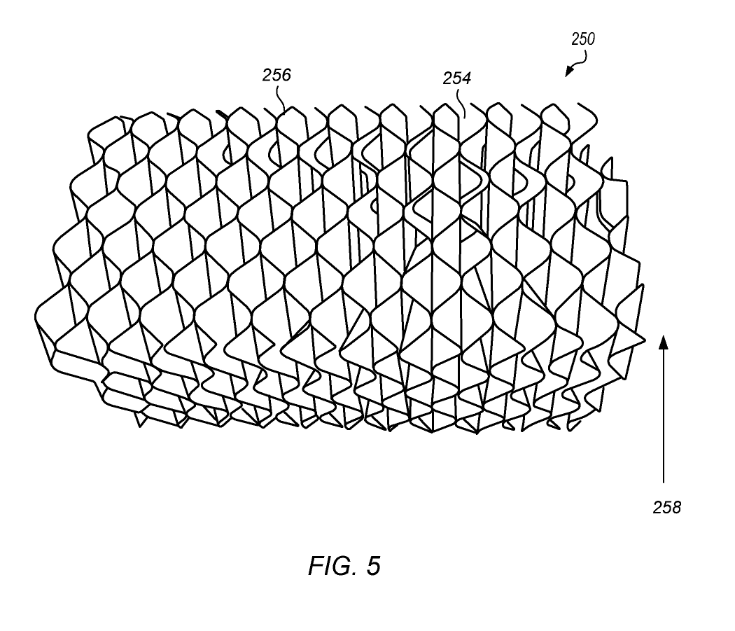

A substrate may be planar, substantially cylindrical, substantially conical, substantially spherical, substantially rectangular, substantially square, substantially oval shaped, and/or irregularly shaped. In some embodiments, a substrate includes a plurality of sheets. For example, as depicted in FIG. 4, substrate 250 includes a plurality of sheets 252 oriented, with respect to each other, such that a plurality of passages are defined by the sheets. In some embodiments, sheets 252 include a plurality of ridges and/or grooves. The sheets may be positioned proximate to each other such that the ridges and/or grooves are at least partially aligned to define a plurality of passages. FIG. 5 depict a projection view of an embodiment of a substrate that includes a plurality of corrugated sheets 256. In this embodiment, corrugated sheets 256 are at least partially aligned to define a plurality of passages 254 through the substrate. When disposed in a bioreactor, substrate 250, as depicted in FIG. 5, is oriented in the direction of flow arrow 258 to maximize the surface area in contact with the wastewater as it flows from the bottom of a bioreactor to the top of the bioreactor.

Bioreactor 200 includes a fluid level sensor 270 to monitor the level of wastewater in the bioreactor system. Fluid level sensor 270 is coupled to a controller which is coupled to the effluent transfer pump 610. Controller, in some embodiments, will control the flow rate of effluent transfer pump 610, at least in part based on the fluid level in bioreactor 200.

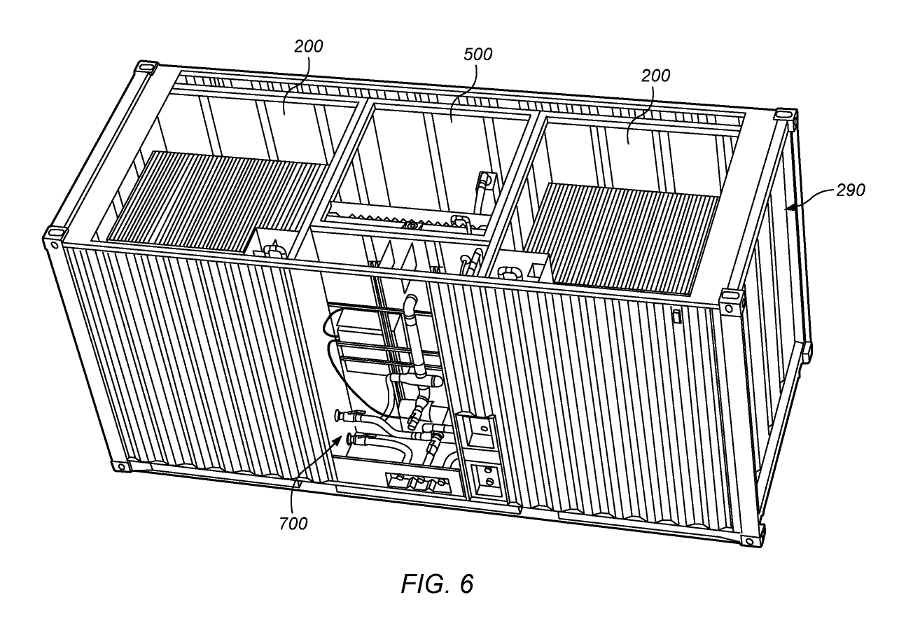

In some embodiments, one or more bioreactors and one or more sedimentation systems may be stored in a portable structure. For example, one or more bioreactors and one or more sedimentation systems may be stored in a high cube, 20′ ISO container. FIG. 6 depicts a portable structure that includes two bioreactors 200 and a sedimentation system 500. Sedimentation system 500 is coupled to the two bioreactors 200 through various plumbing connections disposed in control compartment 700. In some embodiments, portable structure 290 includes integral roof ports and one or more side doors that allow for accessibility to the tanks and equipment within the structure.

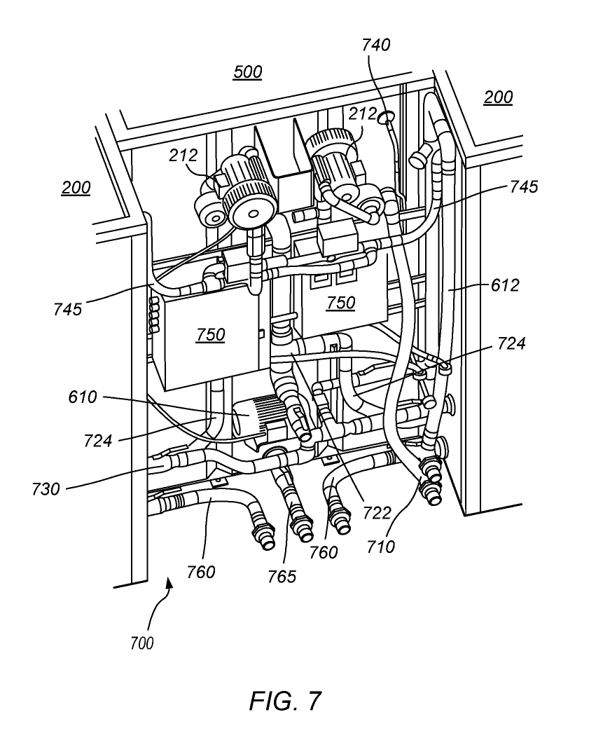

FIG. 7 depicts a projection view of control compartment 700. Components of control compartment 700 couple the two bioreactors 200 to sedimentation system 500. A wastewater inlet conduit 710 is disposed in control compartment 700. Wastewater inlet conduit 710 receives wastewater from a non-buffered wastewater source or from buffer system 400. Wastewater inlet conduit 710 is coupled to sedimentation system 500 such that the incoming wastewater is transferred directly into sedimentation system 500.

After being processed in sedimentation system 500, wastewater is transferred to sedimentation system outlet conduit 720. Sedimentation system outlet conduit 720 is coupled to connector 722 which directs flow of wastewater from sedimentation system 500 into the bioreactors 200 through bioreactor inlet conduits 724.

After wastewater is processed in bioreactors 200, an effluent stream from each bioreactor exits the bioreactors through bioreactor outlet conduits 730. Treated wastewater passes from bioreactors 200 to effluent transfer pump 610 which sends the treated wastewater out of the treatment system through effluent transfer conduit 612. Treated wastewater, in some embodiments, may be transferred to a purification system 600, as depicted in FIG. 1.

Bioreactors 200 and sedimentation system 500 need to be periodically drained of solid materials that settle during use. Bioreactor drain conduits 760 are coupled to the bottom of bioreactors 200 and allow solids and/or wastewater to be drained from the bioreactors. Sedimentation system drain conduit 765 is coupled to sedimentation system solids outlet 506. Sedimentation system drain conduit 765 allows solids and/or wastewater to be drained from the sedimentation system.

Control compartment 700 may also include additional components used to operate the sedimentation system and/or the bioreactors. For example, control compartment 700 may include a bacteria inlet conduit 740. During use, bacteria, produced in a bacteria generator, may be transferred into the treatment system (e.g., into the sedimentation system) through bacteria inlet conduit 740. In an embodiment, bacteria inlet conduit 740 is coupled to outlet conduit 534 of the sedimentation system. In this configuration, bacteria is added to the at least partially clarified wastewater stream produced in the sedimentation system and flows with the stream into the bioreactors. At least a portion of the bacteria added to the treatment system interacts with the substrate and/or bacteria coupled to the substrate to regenerate the biofilm.

Control compartment also includes effluent transfer pump 610, blowers 212 and electronic controllers 750. Blowers 212 provide compressed air to bioreactors 200 through conduits 745. Conduits 745 may be coupled to valves 747 which control the flow of compressed air from blowers 212 into bioreactors 200. In an embodiment, conduits 745 are configured to allow compressed air to b passed from either blower to either bioreactor, individually or simultaneously. Electronic monitoring devices such as DO sensor flow sensors, etc. that are disposed in either bioreactors 200 or sedimentation system 500 are coupled to electronic controllers 750. Electronic controllers may receive data from the sensor and communicate the information to a central controller.

The overall objectives of biological treatment of wastewater streams are to (1) transform (i.e., oxidize) dissolved and particulate biodegradable constituents into acceptable end products, (2) capture and incorporate suspended and non settleable colloidal solids into a biofilm, (3) transform or remove nutrients, such as nitrogen and phosphorus, and (4) in some cases, remove specific trace organic constituents and compounds.

In one embodiment, a wastewater treatment system utilizes physiologically active microorganisms that are in logarithmic growth stage and are capable of participating in a biofilm on a hydrophobic substratum. In an embodiment, a microbial consortium is utilized in a bioreactor for the treatment of wastewater. The microbial consortium utilized in embodiments of a wastewater system is designed such that specific bacterial strains contribute to different aspects of healthy biofilm formation. For example, certain bacteria may be selected for their ability to perform adhesion to a substrate, while others were selected on their ability to assist in intercellular adhesion.

The removal of dissolved and particulate carbonaceous material and the stabilization of organic matter found in wastewater is accomplished biologically using a variety of microorganisms, principally bacteria. Microorganisms are used to convert (e.g., oxidize) the dissolved and particulate carbonaceous organic matter into simple end products and additional biomass. Microorganisms may also be used to remove nitrogen and phosphorus in wastewater treatment processes. Specific bacteria are capable of oxidizing ammonia (nitrification) to nitrite and nitrate, while other bacteria can reduce the oxidized nitrogen to gaseous nitrogen. The organic material and nutrients are removed from the wastewater flowing past the biofilm. Aerobic heterotrophic bacteria are able to produce extracellular biopolymers that result in the formation of biofilms that can be separated from the treated liquid by gravity settling with relatively low concentrations of free bacteria and suspended solids. Because the biomass has a specific gravity slightly greater than that of water, the biomass can be removed from the treated liquid by gravity settling. It is important to note that unless the biomass produced from the organic matter is removed on a periodic basis, complete treatment has not been accomplished because the biomass, which itself is organic, will be measured as BOD in the effluent. Without the removal of biomass from the treated liquid, the only treatment achieved is that associated with the bacterial oxidation of a portion of the organic matter originally present.

The efficient reduction of the BOD5 of the wastewater stream is accomplished through the utilization of aerobic bacteria. The process requires sufficient contact time between the wastewater and heterotrophic microorganisms, and sufficient oxygen and nutrients. During the initial biological uptake of the organic material, more than half of it is oxidized and the remainder is assimilated as new biomass, which may be further oxidized by endogenous respiration. The small amounts of remaining solids are periodically removed. The solids are separated from the treated effluent by gravity separation as described above.

A wide variety of non-bacterial microorganisms are found in aerobic attached growth treatment process used for the removal of organic material. Protozoa also play an important role in aerobic biological treatment processes. By consuming free bacteria and colloidal particulates, protozoa aid effluent clarification. Protozoa require a longer solids retention time than aerobic heterotrophic bacteria, prefer dissolved oxygen concentrations above 1.0 mg/L, and are sensitive to toxic materials. Thus, their presence is a good indicator of a trouble-free stable process operation. Because of their size, protozoa can easily be observed with a light microscope at 100 to 200 magnification. Rotifers can also be found in biofilms, as well as nematodes and other multicellular microorganisms. These organisms occur at longer biomass retention times, and their importance has not been well defined. Aerobic attached growth processes have a complex microbial ecology.

In some embodiments, one or more bacteria may couple to a substrate in a container to form a biofilm. In an embodiment, bacteria forming the biofilm may not substantially slough off of the substrate, during use. The bacteria may be aerobic. Some of the bacteria may be oligotrophic, heterotrophic, enteric, and/or combinations thereof.

The bacteria may be capable of reducing contaminants in wastewater. In some embodiments, a biofilm may be capable of significantly reducing contaminants in water quickly. For example, wastewater may only have to reside in a container with the biofilm for less than 24 hours to significantly reduce an amount of contaminants in the wastewater.

One or more of the bacteria may reduce an amount of and/or degrade pesticides, industrial wastewater, wastewater from septic systems, and/or municipal wastewater. In some embodiments, one or more of the bacteria may reduce an amount of and/or degrade metal compounds and/or organic compounds such as alkanes, alkenes, aromatic organic compounds, and/or polychlorinated benzenes. Some bacteria may cleave long chain biopolymers into monomers, which other bacteria degrade. In an embodiment, bacteria may degrade at least a portion of organic compounds into at least carbon dioxide and water.

In some embodiments, a biofilm may include one or more primary adherer bacteria and/or one or more secondary adherer bacteria. Primary adherer bacteria may be capable of coupling to one or more substrates in a container and/or other bacteria. In certain embodiments, primary adherer bacteria may couple with a substrate such that the primary adherer bacteria are inhibited from being dislodged from the substrate during use. In an embodiment, primary adherer bacteria may irreversibly couple to a substrate.

Primary adherer bacteria may have longitudinal and latitudinal sides. In some bacteria, a longitudinal side may be longer than a latitudinal side or vice versa. Primary adherer bacteria may couple to bacteria and/or a substrate along a longitudinal and/or a latitudinal side. In an embodiment, a type of primary adherer bacteria may only couple to a substrate on one of its latitudinal sides. Another type of primary adherer bacteria may only couple to a substrate on one of its longitudinal sides. A shape and/or a density of a biofilm may be controlled by selecting one or more types of primary adherer bacteria that have a preference for coupling with substrate along a specific side.

In some embodiments, primary adherer bacteria may include a stalk. For example, bacteria in the genus Caulobacter have a stalk. A stalk may be a narrower than the body of the primary adherer bacteria. A stalk may be capable of coupling to inanimate objects. An end of a stalk of a primary adherer bacteria may be couple to an inanimate object, such as a substrate, but not couple to bacteria. For example, an end of a stalk of a primary adherer bacteria may include a holdfast, such as a sugar based holdfast, which allows the end of the stalk to bind with a substrate.

In an embodiment, a stalk may grow. A stalk of a primary adherer bacteria may be capable of growing from about 5 nm to about 200 nm. It may be advantageous to utilize a bacteria capable of extending a biofilm. If a food source is not plentiful proximate primary adherer bacteria with stalks, the stalks may grow to position the primary adherer bacteria in another region of the fluid with a greater food source.

Primary adherer bacteria may include one or more filaments, such as organelle, capable of coupling with other bacteria. For example, bacteria in the genus Gordonia have several filaments. Some primary adherer bacteria may have filaments capable of coupling only with other types of bacteria (e.g., the filaments will not couple with the same primary adherer bacteria from the same genus).

In some embodiments, primary adherer bacteria may include bacteria from the class Actinobacteria Alphaproteobacteria, or combinations thereof. Primary adherer bacteria may include bacteria from the genus Gordonia, Caulobacter, or combinations thereof.

Secondary adherer bacteria may be capable of coupling with one or more other bacteria including primary adherer bacteria. In some embodiments, secondary adherer bacteria may not be capable of coupling to a substrate. In an embodiment, secondary adherer bacteria may include bacteria from the class Bacilli, Gammaproteobacteria, Betaproteobacteria, or combinations thereof. Secondary adherer bacteria may include bacteria from the genus Bacillus, Pseudomonas, Zoogloea, Enterobacter, or combinations thereof.

Primary adherer bacteria and/or secondary adherer bacteria may be capable of reducing contaminants in water. Secondary adherer bacteria may be capable of reducing a greater amount of one or more types of contaminants than one or more of the primary adherer bacteria. In some embodiments, sessile bacteria may experience gene-up regulation that increases the metabolic activity of the sessile bacteria. Sessile bacteria may have a metabolic activity four times the metabolic activity of planktonic bacteria. Primary adherer bacteria may experience gene-up regulation of metabolic activity due to their attachment to a substrate and/or secondary adherer bacteria may experience gene-up regulation due to their attachment to other bacteria. In an embodiment, sessile primary adherer bacteria may experience greater gene-up regulation of metabolic activity that sessile secondary adherer bacteria.

In some embodiments, bacteria provided to a container may be selected to reduce specific contaminants. Bacteria may be selected for their ability to withstand a pre-determined amount of a contaminant, such as 100 ppm of aromatic organic compound, and/or fluctuations in pH. For example, bacteria selected may include bacteria from the genus Enterobacter, Pseudomonas, Gordonia, Bacillus, Agrobacterium, Caulobacter, and/or Zoogloea. The biofilm may include bacteria in the genus Nocardia, Thiothrix or Beggiatoa. In an embodiment, a biofilm may include Enterobacter cloacae, Pseudomonas putida, Pseudomonas stutzeri, Gordonia sp., Bacillus subtilis, Agrobacterium sp., Caulobacter vibrioides, Caulobacter crescentus, and/or bacteria in the genus Zoogloea. In another embodiment, a biofilm may be formed from a combination of bacteria, such as FreeFlow®, commercially available from NCH Corp (Irving, Tex.).

In some embodiments, the biofilm may include bacteria of the phylum Actinobacteria phy. nov., class Actinobacteria, subclass Actinobacteridae, order Actinomycetales, suborder Corynebacterineae, family Gordoniaceae, and/or genus Gordonia. In some embodiments, bacteria in the genus Gordonia may have filaments. The filaments may be capable of binding with a substrate and/or other bacteria. The filaments may promote formation of a more even biofilm. Bacteria in the genus Gordonia may be capable of degrading one or more organic compounds, such as benzene, toluene, ethylbenzene, o-xylene, p-xylene, and/or m-xylene. In some embodiments, a biofilm including bacteria in the genus Gordonia may be capable of degrading rubber compounds, desulphurize aromatics, and/or degrade pyridine compounds. Bacteria in the genus Gordonia may be capable of removing sulfur from petrochemical products. In an embodiment, bacteria in the genus Gordonia may produce biosurfactants that facilitate remediation and/or degradation of organic and metal-based contamination. Biosurfactants may assist in the solubilization of various pollutants and/or allow bacteria to more rapidly uptake pollutants for degradation or immobilization.

Bacteria in the genus Gordonia may go into a state of latency during periods of stress, introduction of a toxin, nutrient deprivation, and/or oxygen depravation. Bacteria in the genus Gordonia may be capable of reviving out of the state of latency once the environment becomes conducive to the bacteria. It may be advantageous to utilize bacteria capable of going into a latent state and reviving, so that bacteria in a biofilm may not die if the environment, such as in a bioreactor, changes significantly.

Bacteria in the genus Gordonia may cause foaming in wastewater treatment systems. However, when bacteria in the genus Gordonia are coupled to a substrate, foaming is inhibited and gene-up regulation occurs causing the bacteria to be capable of reducing contaminants from water. The phenomena of bacteria possessing a greater ability to degrade and/or reduce contaminants more efficiently when bound (e.g., gene-up regulation) is not limited to bacteria in the genus Gordonia but is present in several types of bacteria. Using bacteria with increased contamination reduction abilities when bound allows formation of a more stabile biofilm (e.g., since bacteria are coupled to the substrate) and/or a more efficient biofilm.

In some embodiments, the biofilm may include bacteria of the phylum Proteobacteria phy. nov., class Alphaproteobacteria, order Caulobacterales, family Caulobacteraceae, and/or genus Caulobacter. Bacteria in the genus Caulobacter may convert heavy metals such as mercury, copper, cadmium, and cobalt in aqueous solutions into chemical forms that are less toxic, less soluble, and/or precipitate out of solution. Some bacteria in the genus Caulobacter have resistance to some antibiotics such as chloramphenicol, tetracycline, erythromycin, and tobomycin. Resistant bacteria may be from plasmid transfer between antibiotic resistant intestinal or human associated bacteria found in wastewater and bacteria in the genus Caulobacter.

Bacteria in the genus Caulobacter are oligotrophs and may be capable of surviving in low carbon concentration environments. In some embodiments, bacteria in the genus Caulobacter may be capable of forming a uniform biofilm due to the bacteria shape. Bacteria in the genus Caulobacter have a motile stage characterized by a swarmer cell and a sessile stage characterized by a stalk shaped cell. The stalks of the bacteria in the genus Caulobacter may grow. It may be desirable to use a bacteria with a growing stalk since the bacteria may be better able to survive changes in environment. For example, if nutrients proximate a bacterium's location are depleting, then the stalk of the bacterium in the genus Caulobacter may grow and the bacterium can be positioned in a new location with a more nutrients.

While some bacteria are capable of forming a biofilm through the secretion of polysaccharides, bacteria in the genus Caulobacter may be capable of forming a biofilm using a stalk. In an embodiment, using bacteria with stalks may allow the creation of a more uniform biofilm when compared with a biofilm formed without the use of bacteria with filaments. For example, a biofilm may be formed of a first layer including bacteria in the genus Caulobacter and one or more other layers coupled to the bacteria in the genus Caulobacter. The stalks may be capable of coupling to the substrate but may not be capable of coupling to other bacteria. In an embodiment, bacteria in the genus Caulobacter may only couple with a substrate at the holdfast at an end of its stalk.

In an embodiment, bacteria in the genus Caulobacter are capable of frequently entering and exiting a stationary phase. It may be desirable to utilize bacteria capable of entering and exiting the stationary phase, because the bacteria may be more durable and/or capable of surviving environments with fluctuations in levels of nutrients.

In some embodiments, the biofilm may include bacteria of the phylum Proteobacteria phy. nov., class Gammaproteobacteria, order Enterobacteriales, family Enterobacteriaceae, and/or genus Enterobacter. Bacteria in the genus Enterobacter may be enteric, anerobic, and a heterotroph. Bacteria in the genus Enterobacter may produce hydrogen when metabolizing organic compounds. Bacteria in the genus Enterobacter may be capable of degrading aromatics, such as 2,4,6-trinitrotoluene that is commonly found in wastewater produced in munitions production. Bacteria in the genus Enterobacter may be capable of degrading nitrate esters, such as pentaerythritol tetranitrate and glycerol trinitrate.

In some embodiments, the biofilm may include bacteria of the phylum Firmicutes phy. nov., class Bacilli, order Bacillales, family Bacillaceae, and/or genus Bacillus. Bacteria in the genus Bacillus may be good oligotrophs and capable of surviving in an environment with a low concentration of organic compounds. Bacteria in the genus Bacillus may be capable of degrading organic compounds, such as organic compounds produced from plant and animal sources (e.g., cellulose, starch, pectin, proteins, hydrocarbons). In an embodiment, a biofilm including bacteria in the genus Bacillus may cleave long chain biopolymers into monomers that are degradable by other bacteria. Bacteria in the genus Bacillus may be cable of nitrification, denitrification, and/or nitrogen fixation. Bacteria in the genus Bacillus may be capable of fermenting carbohydrates, producing glycerol and butanediol, producing enzymes for utilization in detergents, paralyzing insects, degrading biopolymers, and/or synthesis for use in industrial processes such as the production of antibiotics.

In some embodiments, it may be desirable to utilize bacteria in the genus Bacillus to create a biofilm capable of surviving in harsh environments. Bacteria in the genus Bacillus may produce spores that are highly resistant to stressful environments and/or toxic environments. Bacteria in the genus Bacillus may synthesize antibiotics that kill proximate bacteria and cause the dead bacteria to lyse and release their contents. Bacteria in the genus Bacillus may absorb the nutrients released by the ruptured cells. This process may require less energy than forming spores.

In some embodiments, the biofilm may include bacteria of the phylum Proteobacteria phy. nov., class Gammaproteobacteria, order Pseudomonadales, family Pseudomonadaceae, and/or genus Pseudomonas. Bacteria in the genus Pseudomonas may be good heterotrophs. Bacteria in the genus Pseudomonas may be capable of degrading organic compounds, such as trichloroethylene. In an embodiment, bacteria in the genus Pseudomonas may degrade monomer organic compounds. Bacteria in the genus Pseudomonas may be capable of degrading aromatic organic compounds such as toluene, xylene, naphthalene, or polynuclear aromatic organic compounds. In certain embodiments, bacteria in the genus Pseudomonas may prefer to degrade simple organic compounds when compared to other organisms.

In some embodiments, it may be desirable to include bacteria in the genus Pseudomonas in a biofilm since they are capable of withstanding fluctuations in environment. Bacteria in the genus Pseudomonas may produce o-acetylated alginate that encapsulates the bacteria to protect the bacteria from stressful environments. Bacteria in the genus Pseudomonas may have filaments. The filaments may help bacteria in the genus Pseudomonas to attach to substrates and/or other organisms. The filaments and production of alginate by bacteria in the genus Pseudomonas may promote formation of a biofilm and/or formation of a biofilm coupled to a substrate.

In certain embodiments, the biofilm may include bacteria of the phylum Proteobacteria phy. nov., class Betaproteobacteria, order Rhodocyclales, family Rhodocyclaceae, and/or genus Zoogloea. Bacteria in the genus Zoogloea may be a good heterotroph. Bacteria in the genus Zoogloea may be capable of degrading high concentrations of proteins. Bacteria in the genus Zoogloea may produce exopolysaccharide that contributes to the ability of a biofilm containing bacteria in the genus Zoogloea to tolerate fluctuating, stressful, and/or toxic environments.

In various embodiments, the biofilm may include bacteria of the phylum Actinobacteria phy. nov., class Actinobacteria, order Actinomycetales, suborder Corynebacterineae, family Nocardiaceae, and/or genus Norcardia; bacteria of the phylum Proteobacteria phy. nov., class Gamma proteobacteria, order Thiotrichales, family Thiotrichaceae, and/or genus Thiothrix; and/or bacteria of the phylum Proteobacteria phy. nov., class Gamma proteobacteria, order Thiotrichales, family Thiotrichaceae, and/or genus Beggiatoa. Bacteria of the suborder Corynebacterineae and bacteria of the family Thiotrichaceae may have similar behavior. For example, both may experience gene-up regulation of metabolic activity when attached to a substrate. In an embodiment bacteria of the suborder Corynebacterineae and bacteria of the family Thiotrichaceae may cause foaming in a container when planktonic.

In some embodiments, one or more bacteria generators may provide one or more of the bacteria that form, supplement, and/or replenish the biofilm in a container. A bacteria generator may be a container capable of incubating one or more types of bacteria. In one embodiment, bacteria generator may produce more than one type of bacteria simultaneously. In other embodiments, a system may include a plurality of bacteria generators, one bacteria generator for each strain or set of strains of bacteria that form the biofilm. Bacteria generators may be BioAmp® typy bacteria generators, commercially available from NCH Corp (Irving, Tex.). Bacteria generators may include one or more nutrient sources and/or be coupled to one or more containers such that bacteria from the bacteria generator is provided to the container. Bacteria generator may be capable of producing a predetermined amount of bacteria in less than 48 hours. In an embodiment, bacteria generator may be capable of producing a predetermined amount of bacteria in less than 24 hours. In an embodiment, bacteria generator may facilitate rapid formation of a biofilm in a bioreactor, since bacteria can be supplied to the biofilm to supplement growth of the bacteria in the bioreactor. Bacteria generator may be capable of producing different combinations and/or ratios of bacteria during use. In addition, unlike many automated bacteria incubators, the bacteria generator may be capable of inoculating the bacteria in the bacteria generator, as desired.

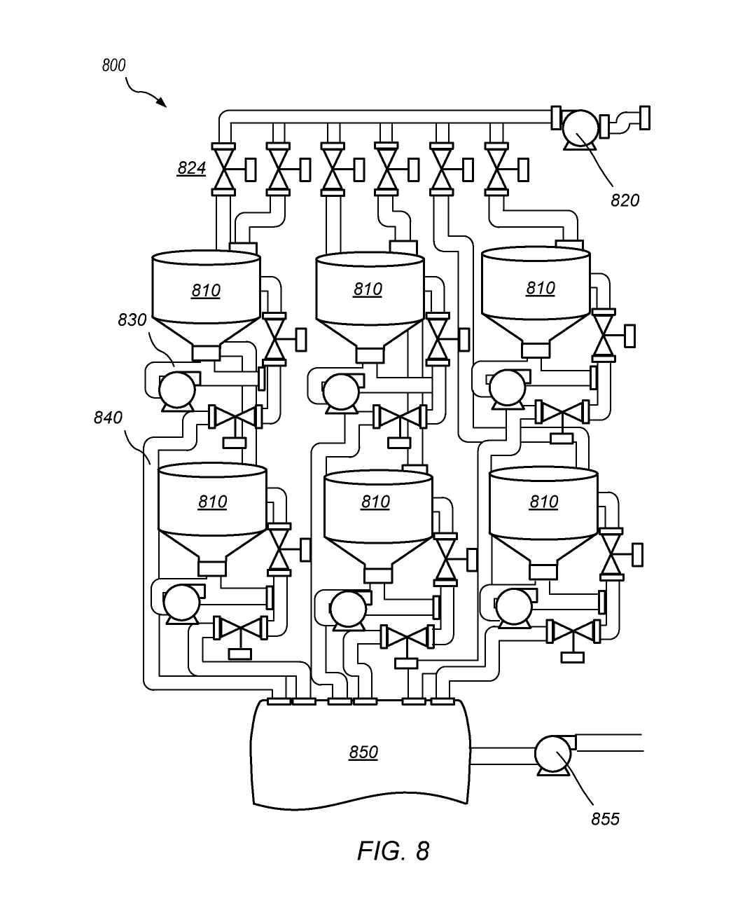

FIG. 8 depicts an embodiment of a bacteria generation system 800 that includes a plurality of bacteria generators 810 that generate bacteria to be used in a bioreactor. Each bacteria generator 810 may be operated simultaneously or individually to generate bacteria. In some embodiments, each bacteria generator 810 is used to generate a different strains of bacteria. Alternatively some or all of the bacteria generators may generate the same strain or strains of bacteria. Bacteria generation system 800 includes fluid supply system 820 which includes pump 822 and a plurality of valves 824. Pump 822 is coupled to a fluid source and transfers fluids from the fluid source to one or more of bacteria generators 810. The fluid source may be water or a water based bacterial growth medium. If water is used as the fluid source, the process of generating bacteria includes adding bacterial growth medium to the bacteria generators being used to generate the bacteria. One or more of valves 824 may be opened to appropriately direct fluid from pump 822 to one or more of the bacteria generators.

Each of bacteria generators 810 include a recirculation conduit 830 and a drain conduit 840. Recirculation conduit 830 is used to circulate the fluids out of, and back into, a bacteria generator. This creates the necessary agitation/mixing to ensure proper growth of the bacteria in the bacteria generator. By using a recirculating mixture, mechanical agitation of the bacteria generators is not necessary. Drain conduits 840 allow bacteria formed in bacteria generators 810 to be removed and collected for use in a bioreactor. The generated bacteria are collected in a bacteria collection tank 850. Bacteria collection tank 850 is coupled to bacteria transfer pump 855, which sends bacteria, in some embodiments, to bacteria inlet conduit 740 of the sedimentation system (See FIG. 7).

Bacteria used in bacteria generators 810 may be in a preserved state. In one embodiment, bacteria are generated using bacteria generators by filling one or more of bacteria generators 810 with an appropriate amount of water. Growth medium (for example as a dry powder, or as a concentrate) is added to one or more of bacteria generators 810 and the growth medium is mixed with the water by recirculating the mixture until substantially homogenous. Bacteria stored in a preserved state are added to one or more of the bacteria generators and the mixture is mixed for a time sufficient to increase the concentration of bacteria in the bacteria generators used. After the bacteria is generated, the produced bacteria is drained from the bacteria generators into bacteria collection tank 850. From bacteria collection tank 850 the generated bacteria may be transferred to one or more bioreactors through the sedimentation system.

To preserve bacteria. one or more types of bacteria are incubated and allowed to grow and/or reproduce in the presence of one or more nutrients. In an embodiment, bacteria may be incubated and reproduce in one or more bacteria generators. The flow of nutrients is then terminated and the bacteria are allowed to enter a starvation phase. In an embodiment, the starvation phase for the bacteria may be identified by determining when exponential growth of the bacteria has ended. The change in the number of bacteria may be monitored spectroscopically. The bacteria in the starvation phase may then be preserved.

In some embodiments, the bacteria may be inoculated prior to preservation. Bacteria in the starvation phase produce stress proteins that protect the bacteria from shock. Therefore, when bacteria are inoculated, a greater percentage of bacteria in the starvation phase would be able to survive the shock due to the increased production of stress proteins. Stressing bacteria prior to preservation may allow hardier bacteria to survive the stress of inoculation while the weaker bacteria may die during inoculation. Therefore, it may be advantageous to stress bacteria prior to preserving the bacteria, since the shock may only allow hardier bacteria to be preserved.

It may be advantageous, in some embodiments, to preserve bacteria in the starvation phase. The starvation phase occurs during the stationary phase of bacteria. During the starvation or stationary phase, the rate of change of the number of bacteria is approximately constant since the number of bacteria generated is approximately the same number of bacteria that die. Using bacteria in the starvation phase may also be desirable, since when starved bacteria are introduced into an environment with nutrients, the bacteria are hungrier and more competitive for the available carbonaceous material.

In some embodiments, bacteria in the starvation phase may be preserved as bacteria-alginate beads, where the bacteria is immobilized in a bead. To produce bacteria-alginate beads, bacteria is mixed with an alginate, such as sodium alginate. In an embodiment, alginate is added to an aqueous solution including the bacteria in the starvation phase. In another embodiment, bacteria in the starvation phase may be added to an aqueous alginate solution. The sodium alginate or a viscous aqueous solution containing alginate may be autoclaved at a temperature from approximately 115° C. to approximately 125° C. The bacteria-alginate mixture is stirred. The viscosity of the bacteria-alginate mixture may increase while stirring. The bacteria-alginate mixture is then added to an aqueous solution containing calcium ions.

In an embodiment, the bacteria-alginate mixture is added in drops to the aqueous solution containing calcium ions. Bacteria-alginate particles are allowed to form in the calcium ion solution. The bacteria-alginate particles may be firm and not as compressible as a gelatinous substance. The bacteria-alginate particles may be separated from the solution and/or dried. The bacteria-alginate particles may be filtered from the solution in an aseptic environment. The preserved bacteria-alginate particles may be stored until needed and/or used in bacteria generators in a system for the reduction of contaminants in water. In an embodiment, when the bacteria-alginate particles are revived in a solution of nutrients, the bacteria may consume and/or degrade the alginate portions of the particle.

The size and shape of the bacteria-alginate particles may be controllable. The amount of bacteria-alginate mixture added or dropped into the calcium solution may control the size of the particles formed. The bacteria-alginate mixture may be sprayed onto the aqueous solution containing calcium ions to produce small substantially spherical-shaped particles. Particles that are substantially cubic, pyramidal, conical, or irregularly shaped may also be formed.

In other embodiments, bacteria in the starvation phase may be preserved on hydrophobic substrates. To produce immobilized bacteria in the starvation phase on a hydrophobic substrate, bacteria may incubate in a solution containing one or more hydrophobic substrates until the bacteria are in the starvation phase. Alginate is mixed in an aqueous solution and may be autoclaved at a temperature from approximately 115° C. to approximately 125° C. The hydrophobic substrate that includes the bacteria in the starvation phase may then be introduced into the alginate solution. Alginate may at least partially saturate the hydrophobic substrate. The hydrophobic substrate then may be contacted with an aqueous solution containing calcium ions. The hydrophobic substrate may be separated from the solution and/or vacuum filtered. The hydrophobic substrate may be allowed to dry. In certain embodiments, the hydrophobic substrate containing preserved bacteria in the starvation phase may be stored until needed, used in bacteria generator in a system for reduction of contaminants in water, and/or added to a container to form a biofilm.

Although adding bacteria-alginate mixture to calcium ions is described, other metal ions solutions may be used successfully as well, including barium, copper, or zinc metal ion solutions. It may be desirable to use a calcium ion solution because calcium is available at a low cost from sources such as limestone and/or calcium is not generally considered a contaminant, unlike copper or zinc.

Preserving bacteria in particles or immobilizing bacteria on hydrophobic substrates may allow the preserved bacteria to be more resilient to environmental stress and/or toxins and/or may reduce cell mortality upon revival. Unlike when using preservation methods currently known in the art, such during lyophilization or the formation of compressed tablets, the bacteria are not dried to desiccation when bacteria are in particles or immobilized on substrates. Although lyophilized bacteria and compressed pellet bacteria have long shelf lives, it may take a long period for the bacteria to acclimate to surroundings and return to an exponential growth stage. Bacteria in particles and immobilized on substrates may become physiologically active within a shorter period of time since the cells do not have to be hydrated since they were not desiccated to the same extent during preservation.

In some embodiments, the preserved bacteria in particles and/or hydrophobic substrate may be added to bacteria generator to produce bacteria for a container in a system for the reduction of contaminants in wastewater. The preserved bacteria may be revived from the starvation phase and enter exponential growth phase when introduced into an aqueous solution containing nutrients. The preserved bacteria may consume the alginate in the particle and/or hydrophobic substrate. After a period of incubation, the bacteria may then be introduced into a container to form and/or replenish a biofilm. In an alternative embodiment, preserved bacteria in or on hydrophobic substrate may be added directly to a container to form a biofilm.

Wastewater treated in a treatment system that includes one or more bioreactors may be further purified by passing the treated wastewater stream to a purification system 600. Purification system may include one or more filtration systems that receive an effluent stream from one or more of the bioreactors and produces a filtered water stream. Examples of filtration systems that may be used include, but are not limited to a granulated activated carbon filter or a membrane-based filter. An activated carbon filter may remove organic compounds, metal ions, fine particles and/or bacteria from fluid flowing through activated carbon filter. Membrane based filtration include reverse osmosis, micro, and ultrafiltration membranes.

Metal removing system 600 may also include electrocoagulation and electroplating systems. An electrocoagulation system may be used to precipitate metal ions for removal. In an embodiment, an electrocoagulation system may charge ions in a fluid between two charged metal objects (e.g., metal plates or rods) disposed at a fixed distance from each other. When an electrical potential is applied to the metal objects, charged ions may bind to oppositely charged ions and form a precipitate. The formed precipitates may float to a top surface or sink to a bottom surface of the metal removing system for removal from the fluid. In an embodiment the precipitates may be filtered out of the fluid. An electroplating system may also include two charged metal objects disposed at a fixed distance from each other. When an electrical potential is applied to the metal plates, metal ions between the charged metal objects may become plated onto one or both of the metal objects. In some embodiments, a metal removing system may be capable of both precipitation and plating of metal ions. Metal removing systems are described in further detail in U.S. Pat. No. 7,914,662, which is incorporated herein by reference.

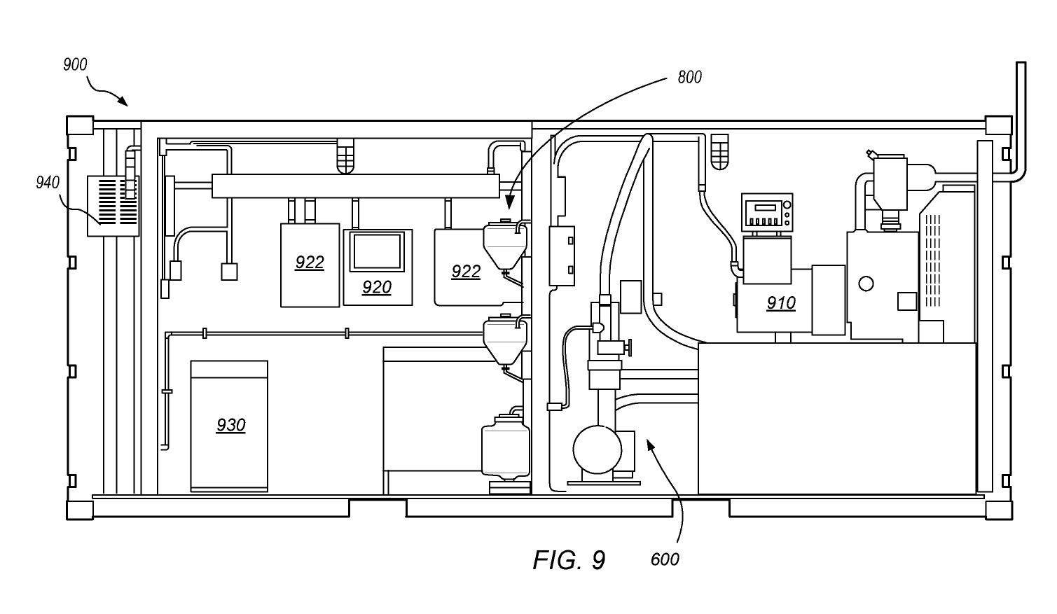

Purification system 600 and bacteria generation system 800 may be positioned in a structure 900. In some embodiments, structure 900 is a portable structure. For example, structure 900 may be an a high cube, 20′ ISO container. FIG. 9 depicts a structure 900 that includes a purification system 600, a bacteria generation system 800, a power generator 910, a controller system 920, electrical panels 922, a cooler 930 for the preservation of bacteria, and a cooling system 940 for controlling the temperature inside the structure. Power generator 910 is used to generate power to operate controllers, valves and sensors during operation. Power generator also supplies power for bacteria generator, and cooling systems. In some embodiments, generator is a diesel or gas powered generator. Controller 920 may be capable of controlling operation of the components of the wastewater treatment system. For example, controller 920 may be a computer that is coupled, through electrical panels 922 to various valves and sensors in a wastewater treatment system. Computer controller 920 is capable of implementing software configured to allow automatic, semi-automatic, and/or manual operation of the wastewater treatment system. Cooler 930 may be a refrigerator that is capable of maintaining bacteria in a dormant state. Cooling system 940 may b a fan or air conditioning unit that allows the temperature inside the structure to be controlled.

In some embodiments, a wastewater treatment system may be divided into separate portable structures. A portable structure may be formed of plastic, metal, and/or other materials. A portable structure may include one or more coatings. A coating may inhibit corrosion and/or facilitate removal of solids from the portable structure. For example, a portable structure may have a polytetrafluoroethylene coating to inhibit corrosion and to inhibit solids from adhering to the container. In some embodiments, a footprint of a portable structure may be substantially square, substantially circular, substantially oval, substantially rectangular, and/or irregularly shaped.

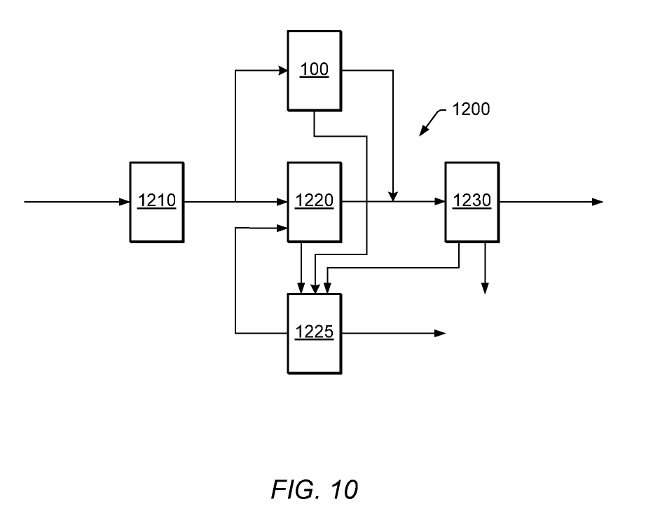

A wastewater treatment system 1200 that includes one or more biological wastewater treatment systems 100 is depicted in FIG. 10. It should be understood that where one biological wastewater treatment system is shown, more than one biological wastewater treatment systems may be used. As shown in FIG. 10, wastewater treatment system 1200 includes primary treatment system 1210, secondary treatment system 1220, disinfection system 1230 and solids treatment system 1225.

Raw wastewater may enter primary treatment system 1210. In some embodiments, the raw wastewater passes through one or more large screens or grids prior to entering primary treatment system 1210. The screens and/or grids remove large floating objects such as rags, cans, bottles, sticks, limbs, grit, and/or sand that may clog pumps, pipes, and/or processes positioned downstream of the screens and/or grids. In certain embodiments, the screens and/or grid may be positioned at an incline. In some embodiments, grinding systems may be used alone or in combination with the screens and/or grids. The grinding systems may reduce the size of the solid materials in the wastewater stream. The smaller objects may be left in the wastewater as it passes to primary treatment system 1210.

In primary treatment system 1210, suspended solids are removed from the water using techniques known in the art such as sedimentation, gravity settling, chemical coagulation, or filtration. Primary treatment system 1210 may include, but is not limited to, a settling tank (primary clarifier), filter, and/or equipment known in the art to remove suspended solids from water. As wastewater enters a settling tank of primary treatment system 1210, the wastewater slows down and the suspended solids sink to the bottom of the tank. Mechanical equipment may remove the settled solids from settling tank. The solids may be removed on a continuous or intermittent basis.

Separated wastewater from settling tank may enter secondary treatment system 1220. In secondary treatment system 1220, organic material in the wastewater is removed using biological treatment processes such as attached growth processes, suspended growth processes, and/or activated sludge processes. Secondary treatment system 1220, in some embodiments, includes an aeration unit and/or a settling unit.

In embodiments using attached growth or fixed film processes, microbial growth occurs on the surface of stone or polymeric media. Wastewater passes over the media in the aeration unit along with air to provide oxygen to the bacteria. Attached growth processes may include, but are not limited to, trickling filters, biotowers, rotating biological contactors or combinations thereof. Attached growth processes may remove biodegradable organic material from the wastewater. Bacteria, algae, fungi and other microorganisms grow and multiply forming a biologically active mass (biomass) on the media. In the treatment process, the bacteria use oxygen from the air and consume most of the organic matter in the wastewater as food. As the wastewater passes down through the media, oxygen-demanding substances are consumed by the biomass and the water leaving aeration unit of the secondary treatment system 1220. Portions of the biomass slough off the media and are removed from the wastewater in a settling unit (secondary clarifier).

In embodiments using suspended growth processes, biodegradable organic material are removed and organic nitrogen-containing material are converted to nitrates. In suspended growth processes, a suspension of water and microbial growth media is placed in an aeration unit of the secondary treatment system 1220. In aeration unit, wastewater is mixed with air and the microbial growth media for a period of time. Excess sludge generated in the process may be removed in settling unit.

In embodiments using activated sludge processes, oxygen is supplied by mixing air with wastewater and biologically active solids in an aeration unit. In some embodiments, mechanical aeration of the wastewater/solid mixture may be accomplished by drawing the sewage up from the bottom of the tank and spraying over the surface, thus allowing the bacteria in the wastewater to absorb large amounts of oxygen from the atmosphere. In certain embodiments, pressurized air may be forced out through small opening in pipes suspended in the wastewater. In other embodiments, a combination of mechanical and forced aeration is used to treat the wastewater. Sludge generated in an activated sludge process is removed from the water in a settling unit of the secondary treatment unit 1220. In some embodiments, the sludge is recycled to the aeration unit.

A slurry of water and sludge generated from the above aeration processes exits aeration unit enters a settling unit. In the settling unit, at least a portion of the sludge is separated from the water using gravitation and/or mechanical means.

A wastewater treatment system 1200 may include one or more biological wastewater treatment systems 100. In one embodiment, a biological wastewater treatment system 100 is used to supplement and/or replace the secondary treatment system 1220. For example, biological wastewater treatment system 100 may be coupled to primary treatment system 1210 such that a portion of the water stream produced in primary treatment system 1210 is diverted to the biological wastewater treatment system 100. In this manner, the capacity of a wastewater treatment plant may be increased with minimal modifications to the existing infrastructure. Biological wastewater treatment system 100 is coupled to disinfection system 1230 and solids treatment system 1225. Biologically treated effluent from biological wastewater treatment system 100 is transferred to disinfection system 1230. Solids and sludge, produced during biological treatment of a wastewater stream in biological wastewater treatment system 100 is transferred to solids treatment system 1225.

In some embodiments, the water stream may be processed in disinfection treatment system 1230 using methods described herein and/or known techniques in the art to produce potable water and effluent. In disinfection treatment system 1230, the water may be treated to destroy and/or kill at least a portion of the biological contaminants in the water. Treatments to remove biological contaminants in a disinfection unit include, but are not limited to, chlorination of the water, ozonation of the water, ultraviolet radiation of the water, or combinations thereof. The disinfection treatment system 1230 may also include a clarifier. In a clarifier, water is purified by removing any nitrogen compounds and/or phosphorus compounds, and/or by stabilizing any oxygen demanding microorganisms in the water. Such purification may be done using any physical/chemical separation techniques known in the art. Examples of purification techniques include, but are not limited to adsorption, flocculation/precipitation, filtration, ion exchange, reverse osmosis or combinations thereof. Processing of the water in disinfection treatment system produces potable water and an effluent. The processed water may exit the disinfection unit and, ultimately, may also be discharged into one or more receiving water bodies. In some embodiments, the effluent may be treated to remove impurities that degrade the quality of receiving water bodies and/or inhibit aquatic life. These impurities include, but are not limited to, chlorine, biological nutrients (e.g., nitrogen and phosphorus compounds), trace amounts of organic and/or inorganic compounds (e.g., volatile organic compounds), or combinations thereof. In some areas of the world, governments have set standards for impurity levels in the effluent. For example, the effluent may be dechlorinated by treating the effluent with one or more additives suitable to oxidize the chlorine. Examples of dechlorination additives include, but are not limited to, sulfur dioxide, metabisulfite, sodium bisulfite, a peroxide compound (e.g., hydrogen peroxide), or mixtures thereof.

The presence of nitrogen in the form of ammonia in the effluent may be toxic to aquatic life, stimulate algae growth, and/or exert a direct demand on oxygen required for biological processes. Nitrogen may be removed from the effluent by contacting the effluent with nitrifying bacteria that may convert the ammonia to nitrate. Additional bacteria may be added to the effluent to convert nitrate into nitrogen, which may be released into the atmosphere.

In some embodiments, phosphorus is removed from the effluent to inhibit algae growth in receiving water bodies that receive the effluent. Phosphorus may be removed through chemical addition and/or a coagulation-sedimentation process. In some embodiments, bacteria selective for phosphorus removal may be used. Chemical addition and/or coagulation-sediment process to remove phosphorus may involve addition of additives that upon contact with the phosphorus floc or clump together. These flocs and/or clumps may be removed using filtration techniques known in the art and/or sent to solid treatment system 1225.

One or more treatments and/or units may be necessary to remove impurities from the waste stream to produce an effluent that is suitable for discharge into receiving water bodies. Use of the fluid treatment system as part of a disinfection treatment system and/or after the waste stream has exited a clarifier may reduce the number of treatments and/or units required to produce an effluent suitable to be discharged to one or more receiving bodies.

Sludge from secondary treatment system 1220, biological wastewater treatment system 100, and disinfection treatment system 1230 enters solid treatment system 1225. In solid treatment system 1225, sludge may be treated to control odors, reduce the number of pathogens, remove water, remove volatile compounds, or combinations thereof. Biosolids produced in solid treatment system 1225 may be sent to a biosolid transport site where the biosolids are transported to disposal facilities or other processing facilities. For example, biosolids may be disposed by spreading on land as fertilizer.

In certain embodiments, sludge may be treated with bacteria to remove at least a portion of pathogens in the sludge (e.g., a digestion process). The sludge may be digested and then thickened to form biosolids. In some embodiments, treatment of the sludge with bacteria may occur after the sludge has been thickened. In some embodiments, digestion may be performed under anaerobic conditions. Under anaerobic conditions, methane may be produced and recovered as a source of energy. At least a portion of the digested or thickened sludge may be recycled from solids treatment system 1225 to secondary treatment system 1220. Digested sludge may include nutrients (e.g., cytoplasm) that may be used to aid microbial growth in secondary treatment system 1220. In some embodiments, at least a portion of the digested sludge stream may be mixed with a wastewater stream prior to entering secondary treatment system 1220.

Sludge may include at least 99% by weight water, at least 95% by weight water, at least 90% by weight water, at least 80% by weight water, at least 70% by weight water. Sludge may be thickened using gravity and/or mechanical techniques known in the art to remove at least a portion of the water in the biosolids. Techniques for thickening sludge include, but are not limited to, gravity belt thickening, filtration (e.g., belt-filter press, filter press), drying beds, centrifugation, or combinations thereof. The sludge may be subject to multiple thickening steps to decrease the amount of water in the sludge to produce biosolids. After thickening using conventional techniques, total solids in the biosolids may be at most 15% by weight, at most 10% by weight, at most 5% by weight, or at most 1% by weight. The thickened biosolids may be transported to disposal facilities or other processing facilities. The thickened solids may be dried, composted, or treated with additives such as lime or other alkaline materials, and/or polymers. In some embodiments, treatment of the biosolids with lime, ferric chloride, and/or polymers may change a size of the biosolids. A change in size may facilitate production and/or handling of the biosolids.

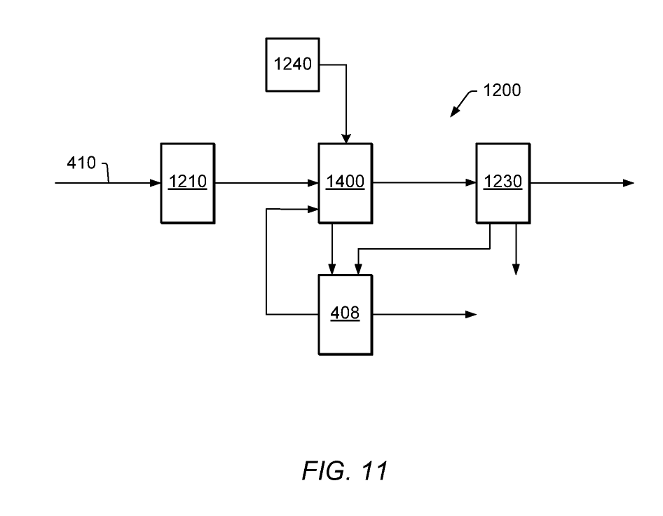

In another embodiment, a wastewater treatment system 1200 includes a primary treatment system 1210, secondary treatment system 1400, disinfection system 1230 and solids treatment system 1225, as depicted in FIG. 11. In some embodiments, secondary treatment system 1400, is a secondary treatment system that has includes a basin that includes one or more substrates used to form a biofilm placed in fixed positions within the basin. As used herein the terms “basin” and “aeration basin” refer to a holding and/or treatment structure provided with artificial aeration to promote the biological oxidation of wastewaters. There are different configurations for the introduction of oxygen containing gas into an aeration basin. Examples of typical configurations include, but are not limited to, floating surface aerators, fixed surface aerators, and submerged aerators. Any of these types, as well as other types of aeration basins, may include one or more of the biofilm supporting structures.

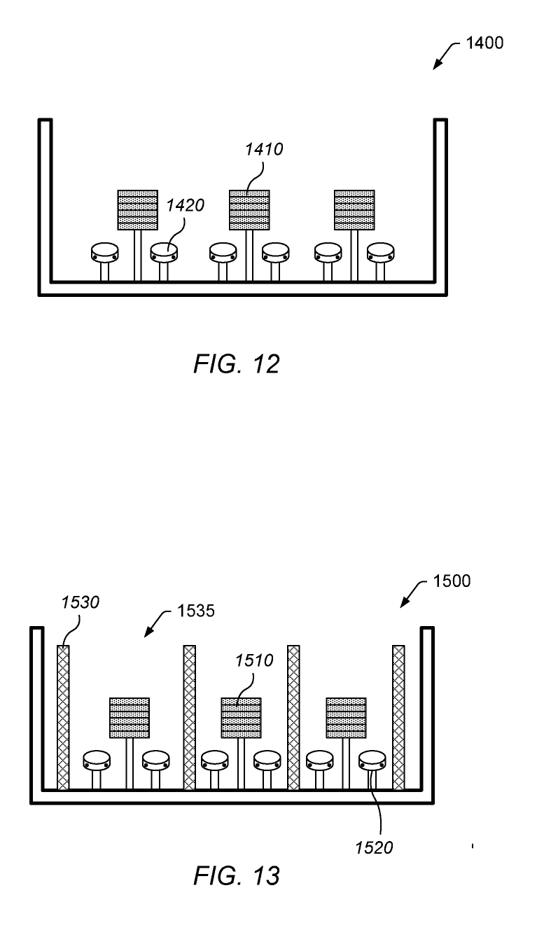

A substrate may be a structure on which a biofilm grows in a container. One or more substrates may be placed in fixed positions within an aeration basin. FIG. 12 depicts an embodiment of an aeration basin 1400 that includes one or more substrates 1410 placed in fixed positions within the aeration basin. In some instances, one or more substrates are removably coupled to the aeration basin to allow easy removal for cleaning or replacement of the substrate. One or more oxygen containing gas diffusers 1420 are disposed within the aeration basin. While FIG. 12 depicts the use of submerged aerators, it should be understood that other configurations of aeration devices (e.g., floating surface aerators and fixed surface aerators) may also be used.

In some embodiments, aeration basin 1400 is an aeration basin that is part of an existing wastewater treatment facility that has been modified to include on or more substrate in a fixed positions in the basin. Based on available space, a series of diffuser manifolds may need to be mounted to the bottom of the aeration basin. In other embodiments, existing diffusers may be used. Spacing between the manifolds, in some embodiments, may be about three meters and the manifolds span the length of the aeration basin to within one meter of the outer wall. After the manifolds have been installed, support structures for the media are installed.

Support structures may be designed to where the bottom of the media is at least one-half a meter from the top of the diffuser manifold. Support structures may be designed to ensure that they are capable of supporting the media, but the support structure does not obstruct the flow of air into the media. Media may be stacked in a manner that will ensure it is completely submerged, at least one-half a meter beneath the air-water interface. The capacity of the pump(s) used to supply air to the diffuser manifolds is specific for each modified treatment facility. The depth of the aeration basins as well as the layout of the facility will impact the method in which air is delivered to the diffuser manifolds. Additionally, water quality probes may be integrated throughout the system to provide the operator with current conditions. Most wastewater treatment facilities currently have dissolved oxygen probes throughout the facility; however additional probes may be used to provide the operator with a continuous stream of data that could allow for improving the plants operation.

A substrate used in an aeration basin may be formed of polymeric material, including, but not limited to, polyvinyl chloride (PVC), polyethylene, and polypropylene. Other materials such as metals and natural materials (e.g., cotton) may be used to form one or more of the substrates. In certain embodiments, the material selected to form the substrate may not substantially degrade in the presence of the wastewater to be treated.

A substrate may be planar, substantially cylindrical, substantially conical, substantially spherical, substantially rectangular, substantially square, substantially oval shaped, and/or irregularly shaped. In some embodiments, a substrate includes a plurality of sheets or a corrugated structure. FIG. 5 depict a projection view of an embodiment of a substrate that includes a plurality of corrugated sheets 256. In this embodiment, corrugated sheets 256 are at least partially aligned to define a plurality of passages 254 through the substrate.

Wastewater treatment plants that have been retrofitted with one or more substrates in an aeration basin may also include an on-site bacteria generator 1240, that supplies the secondary treatment system of a wastewater treatment facility an appropriate consortium of microbes. Bacteria generator 1240 is responsible for the production of the biological inoculum which allows the user to maintain optimum performance through the introduction of select strains of microorganisms. The biological inoculum is responsible for allowing treatment systems to initiate and reach steady state within twenty-four (24) to thirty-six (36) hours of introduction. It has been demonstrated that the inoculum in use is capable of inhibiting less competitive organisms that can reduce the efficiency of typical wastewater treatment systems. The system operations are automatic only requiring periodic replenishment of starter microbes. These bacteria attach to the media inside the structures and serve as the cleaning agent for the wastewater.

An alternate embodiment of a modified aeration basin is depicted in FIG. 13. In this embodiment, an aeration basin 1500 that includes one or more substrates 1510 placed in fixed positions within the aeration basin. In some instances, one or more substrates are removably coupled to the aeration basin to allow easy removal for cleaning or replacement of the substrate. One or more oxygen containing gas diffusers 1520 are disposed within the aeration basin. While FIG. 13 depicts the use of submerged aerators, it should be understood that other configurations of aeration devices (e.g., floating surface aerators and fixed surface aerators) may also be used. Walls 1530 may be placed in the aeration basin defining one or more compartments 1535. In some embodiments, a plurality of compartments divide the basin into a plurality of substantially equal parts. The compartments, in some embodiments, may be defined by one or more concrete walls 1530 positioned in the basin. In an embodiments, inlets and outlets are formed in walls 1530 to allow fluid to flow into and out of compartments 1535. Inlets/outlets may couple the compartments together such that the compartments are operated in parallel (i.e., all active compartments are operated together). In some embodiments, inlets/outlets may couple compartments together such that the compartments are operated in series. When operated in series, the first compartment, of a series of compartments, receives a wastewater stream. The outlet of the first compartment is coupled to the inlet of the next compartment in the series. This is continued until the last compartment is reached. The inlets/outlets may be arranged such that the compartments may be individually operated. Thus, in some embodiments, some or all of the treatment compartments may be in use depending on the treatment needs of the wastewater treatment plant.

If a community that feeds wastewater into a wastewater treatment facility is in a state of decline, a secondary treatment system of the wastewater treatment facility may be modified by installing a series of walls in the aeration basin. By dividing up the total capacity of the plant into a series of treatment compartments, the facility will be able to maintain the optimal treatment capacity and ensure they are able to maintain effluent requirements. Treatment compartments are generally designed to handle upper and lower levels of hydraulic flow, thus a range of capacity is inherent in all treatment systems. If activated sludge plants begin to receive a quantity of water below the specified capacity, for example, problems with operational efficiencies will result due to the fact that food-to-mass ratios cannot be maintained. The use of substrate supported biofilms does not rely on food-to-mass ratios, since the biofilm is capable of automatically adjusting to the incoming load. The advantage to creating a series of compartments is that an operator can reduce energy consumption by taking the cells that are not required for meeting effluent objectives off-line.

If the community is in a state of growth they would not necessarily require the installation of walls between the diffuser manifolds, however there would be advantages to doing so. Creating a grouping of treatment compartments provides the operator the opportunity to increase or decrease the hydraulic capacity. Also if the community requires further upgrades, creating treatment compartments provides a more economical method of increasing capacity and on an as needed basis, thus substantial capital investment would not be required. Other considerations growing communities will have to consider is the development of local industries that could result in higher loading for the treatment facility.

When industry is permitted to transfer waste to a local treatment facility, the incoming load is usually significant and can have negative consequences to the treatment facility by reducing the quality of effluent, thus resulting in potential fines from the local and state regulators. The creation of treatment compartments would allow the operator to adjust the normal hydraulic flow to operate all or specific compartments. For example, a group of compartments may be operated in series, where the effluent from one compartment becomes the input stream for another compartment. This would provide for longer retention times, and allow the operator to treat the higher loads normally associated with industrial wastewater, to levels that would meet local requirements.

Integration of the substrate based biofilms into the current infrastructure of a wastewater treatment facility may lower operational costs. The primary savings may come from the reduced energy requirements and the reduced volume of sludge that must be treated and disposed through landfill operations. The integration of the substrate based biofilms also allows the plant to increase the throughput of the municipal wastewater system. This allows for smaller plant footprint size for treating an equivalent volume. In areas where population growth is expanding, this is a significant advantage. The reduced sludge and high quality of water released from the treatment facility will also reduce the environmental impact of waste operations at every location. Reduction/elimination of odor from treatment plants will also improve the quality of life of people living in areas that have encroached into the proximity of wastewater treatment plants.

Another advantage to integration of integration of the substrate based biofilms is that if an insult occurs to the plant that reduces/eliminates its treatment capacity, a subsequent inoculation of the bacterial consortium, from one or more bacteria generators 1240, will reinitiate the plant. The bacterial consortium described herein has been demonstrated to be capable of achieving steady state within 24-36 hours as compared several weeks that is required for traditional treatment systems. This allows for a large reduction in down time if the plant's treatment system is knocked out and community residents can quickly go back to their normal routine.

The use of substrate based biofilms results in less maintenance since the biofilm is self-regulating. Additionally, the hydraulic retention is about eight (8) hours for a substrate based biofilm, whereas many plants require a hydraulic retention between twenty-four (24) and thirty-six (36) hours. This would result in the ability of treatment plants to increase their capacity in a more economical fashion, when compared to current methods of upgrading treatment facilities.

Use of a substrate based biofilm also results in a significant reduction in sludge production. Sludge production for typical treatment facilities is approximately 40% by weight, while the sludge production for the DAAB is less than 10%. Treatment plants that have used a biological wastewater treatment system 100 on-site for demonstration have reported reductions in sludge production during the course of operation and improvements in their plants effluent. Cost savings result from reduced operation of sludge handling equipment.

Substrate based biofilm also provides a cleaner stream of water to feed into a reverse osmosis (RO) membrane system and allows for 90% recovery (10% reject) of water (normal operation of RO systems result in the recovery of only 60%). If RO systems are integrated for water reuse, further reductions in energy requirements will be achieved. Additionally, these improvement may result in reduced/eliminated odor normally associated with wastewater treatment plants.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Producing Bacteria in the Starvation Phase

Bacteria was incubated in a nutrient broth at a temperature of from approximately 25° C. to approximately 30° C. depending on which bacteria is being preserved. Bacteria in the genus Agrobacterium, Bacillus, Caulobacter, Enterobacter, Gordonia, Zoogloea and Peudomonas were incubated at 30° C. Bacteria in the genus Agrobacterium and Zoogloea were incubated at 26° C. The bacteria were allowed to incubate for 24 to 72 hours without the addition of an additional amount of nutrients. Bacteria in the genus Agrobacterium, Bacillus, Enterobacter, and Peudomonas were incubated for 24 to 48 hours. Bacteria in the genus Caulobacter and Gordonia were incubated for 48 to 72 hours. Bacteria were spectroscopically monitored to determine when exponential growth ceases and bacteria have entered the starvation phase.

In one embodiment, a specific bacteria mixture for use in treating wastewater includes Enterobacter cloacae, Pseudomonas putida, Pseudomonas stutzeri, Gordonia sp., Bacillus subtilis, Agrobacterium sp., Caulobacter vibrioides, Caulobacter crescentus and bacteria in the genus Zoogloea.

### Example 2

### Producing Bacteria-Alginate Particles

40 g of sodium alginate was mixed into an aqueous solution to form solution more viscous than water. The alginate solution was autoclaved at 121° C. for 30 minutes. The alginate solution was then allowed to cool. 500 ml of bacteria in the starvation phase, prepared according to Example 1, was added to the alginate solution to form bacteria-alginate mixture. The bacteria-alginate solution was agitated. The bacteria-alginate solution was added in drops into 2 L of 0.55 M calcium chloride solution. The calcium chloride solution was mixed continuously. Particles, with a length and a width of approximately 5 mm, formed in the calcium chloride solution. The particles were then filtered under at least a partial vacuum using Whatman 40 filter paper, commercially available from Whatman (Middlesex, United Kingdom). The particles were then dried and stored.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A wastewater treatment system comprising:
a primary treatment system, wherein the primary treatment system is configured to remove at least a portion of solid material from a wastewater stream;
a secondary treatment system coupled to the primary treatment system, the secondary treatment system comprising a basin and one or more substrates positioned in fixed locations within the basin; and
one or more bacteria capable of reducing the contaminants in the wastewater stream, wherein one or more of the bacteria couple to one or more of the substrates to form a biofilm.

2. The system of claim 1, wherein one or more compartments are defined within the basin, the one or more compartments comprising one or more of the substrates and one or more oxygen containing gas inlets.

3. The system of claim 1, wherein the basin is an aeration basin that has been modified to include the one or more substrates.

4. The system of claim 1, wherein the basin comprises one or more air diffusers positioned such that air passes from the air diffusers toward one or more of the substrates.

5. The system of claim 1, wherein the substrate comprises a polymer substrate.

6. The system of claim 1, wherein the substrate comprises a ceramic substrate.

7. The system of claim 1, wherein the substrate comprises a plurality of polymeric sheets, wherein the sheets are oriented, with respect to each other, such that a plurality of passages are defined by the sheets.

8. The system of claim 7, wherein one or more of the sheets of the substrate comprise ridges and/or grooves, wherein the sheets are positioned proximate to each other such that the ridges and/or grooves are at least partially aligned to define a plurality of passages.

9. The system of claim 7, wherein the substrate comprises a plurality of corrugated sheets, wherein the sheets are oriented, with respect to each other, such that a plurality of passages are defined by the corrugated sheets.

10. The system of claim 1, wherein one or more of the bacteria comprise primary adherer bacteria that couple to the substrate and wherein one or more bacteria comprise secondary bacteria which couple to the primary adherer bacteria to form a biofilm.

11. The system of claim 10, wherein the secondary bacteria are substantially unable to couple to the substrate.

12. The system of claim 1, wherein one or more of the bacteria comprise bacteria of the genus Caulobacter.

13. The system of claim 1, wherein the system comprises a mixture of bacteria, the mixture comprising bacteria of the genus Caulobacter; bacteria of the genus Enterobacter; bacteria of the genus Pseudomonas; bacteria of the genus Gordonia; bacteria of the genus Bacillus; bacteria of the genus Agrobacterium; and bacteria of the genus Zoogloea.

14. The system of claim 1, further comprising one or more bacteria generators configured to supply bacteria to the basin.

15. The system of claim 1 further comprising a plurality of bacteria generators configured to supply bacteria to the basin, wherein each of the bacteria generators is independently operable.

16. The system of claim 1, further comprising a tertiary treatment system coupled to the secondary treatment system, wherein the tertiary treatment system receives an effluent stream from second treatment system and produces a further purified water stream from the effluent stream.

17. A method of reducing contaminants in a wastewater stream comprising:
conducting a wastewater stream comprising one or more contaminants into a primary treatment system of a wastewater treatment system;
removing at least a portion of solid material from a wastewater stream in the primary treatment system to create an at least partially clarified wastewater stream;
passing the at least partially clarified wastewater stream to a secondary treatment system, wherein the secondary treatment system comprises:
a basin;
one or more substrates positioned in fixed locations within the basin, and
one or more bacteria capable of reducing the concentration of contaminants in the wastewater stream, wherein one or more of the bacteria at least partially adhere to one or more of the substrates;
allowing the wastewater stream to interact with bacteria in the secondary treatment system for a sufficient amount of time to allow the bacteria to reduce the concentration of contaminants in the at least partially clarified wastewater stream.

18-58. (canceled)
